(19) United States
(12) Patent Application Publication
(10) Pub. No.: US 2002/0113217 A1
(43) Pub. Date: Aug. 22, 2002

(54) Method and apparatus for preactivating cationically polymerizing materials

(75) Inventors: Wolf-Dietrich Herold, Seefeld (DE); Dietmar Dengler, Landsberg (DE); Rainer Moest, Germering (DE)

Correspondence Address: Barnes & Thornburg, Ste. 900, 750 17th Street, N.W., Washington, DC, 20006, US

(73) Assignee: DELO Industrieklebstoffe GmbH & Co. KG

(21) Appl. No.: 10/078,460

(22) Filed: Feb. 21, 2002

(30) Foreign Application Priority Data
Feb. 21, 2001 (DE) 101 08 381.5

(51) Int. Cl. G21G 5/00

(52) U.S. Cl. 250/492.1

(57) ABSTRACT

For the pre-activation of cationically polymerizing materials a radiation source is used which has a radiation surface formed by a plurality of LEDs. The radiation surface is spaced a small distance from the material to be irradiated. Irradiation is performed such that the material is heated to less than 50° C. and that a sufficient potlife is achieved which enables the material to be further processed before it cures.

### BACKGROUND OF THE INVENTION

Radiation curing one-component materials have been widely accepted in industrial manufacturing for bonding and potting purposes. For very thin films, curing is effected by electron beams (EB) while for thicker films it is effected by ultraviolet (UV) radiation or visible (VL) radiation.

Radiation-activatable materials are divided into two fundamentally different chemical base materials with their associated reaction mechanisms. One group is comprised by the free-radical curing acrylates (radiation-activated polymerization). What is characteristic for the starting monomers that may be cross-linked by free-radical polymerization is the presence of at least one carbon-carbon double bond in the molecule. In the photo-induced free-radical curing, switching off the light sources will result in the immediate termination of the polymerization even if there still exist monomers and photo initiators. The reason is that the existing free radicals will combine and new primary radicals will not be formed.

The other group of radiation-activatable materials is comprised by the cationically curing epoxides (radiation-initiated polymerization). Here, the curing mechanism is effected on the principle of cationic polymerization. Especially suitable starting monomers are cycloaliphatic compounds such as, for instance, cycloaliphatic epoxides that are readily subjected to ring-opening polymerization. In photo-initiated or photo-induced cationic curing, the curing mechanism is initiated by radiation and proceeds to the final curing even after shut-down of the radiation. Of particular interest in the application of photo-initiable materials is the available “pre-activation”. Here, the material, e.g. an adhesive, after application onto a part to be joined, is briefly exposed to radiation and is thereby activated. Thereafter the second part is joined to the first one. It is a significant advantage that materials which are non-permeable to UV or VL radiation may also be bonded.

Between the pre-exposure and the joining of the parts there exists a period commonly referred to as “potlife”. While the potlife lasts, the properties of the material change only insignificantly as regards viscosity, adhesion and surface skin formation. The curing process starts only subsequently to the potlife and proceeds automatically until the material is finally cured.

The potlife itself is directly dependent on the irradiated energy dose whereby the curing process may be accelerated or decelerated in controlled fashion. This shows that absolutely uniform irradiation of a surface is of paramount significance for pre-activation.

The temperature of the material to be pre-irradiated is a second important potlife parameter. The potlife is significantly shortened with increasing temperature. It would be ideal if an irradiation system resulted either in no temperature increase or in an adjustable, absolutely uniform temperature control across the entire irradiated surface. Conventional irradiation systems, however, generate a high level of uncontrolled and non-uniform thermal radiation, and subsequently one tries to eliminate this by means of filters or dichroic reflectors.

As the potlife is directly dependent on the respective introduced radiation energy, it also changes directly with the decrease in radiation intensity of the lamps. Normally used lamps exhibit a radiation decrease of 50 to 60% throughout their service life. In the manufacturing process, this leads to a high degree of insecurity of the process. Moreover, it is disadvantageous for monitoring purposes that the consumption of electrical power of the lamps is not correlated with the radiated output power.

EP 0 388 775 A1 discloses a method and an apparatus for pre-activating a cationically polymerizing adhesive. The adhesive is placed in a transparent supply container in which it is irradiated for a period of 0.5 to 300 seconds upon which it is fed to a remote application site through a hose or tube. The irradiation is done by means of a conventional lamp, with the problems discussed above.

### SUMMARY OF THE INVENTION

It is an object of the present invention to keep the potlife of cationically polymerizable materials during a manufacturing process as stable as possible for an extended period of time (1,000 to 10,000 hours)

This object is met by using a radiation source that produces the required radiation by LEDs.

The radiation source used in accordance with the present invention preferably comprises an array of light emitting diode (LED) for uniformly illuminating all of the surface to be pre-activated. As every individual LED possesses only a small radiated power, a plurality of diodes are tightly packed side by side to form a large radiation surface. Appropriately, the LED array is placed at a distance of just a few millimeters from the surface of the material to be pre-activated.

The radiation performance of an LED offers many advantages. An LED emits only in a very narrow electromagnetic band of some few nanometers. Very good matching of the absorption band of the photo-initiator and the emission band of the source of radiation is thereby possible. In view of the known photo-initiators for cationic systems, the narrow electromagnetic radiation band of the diodes (30 to 50 nm) should be at the wavelength of from 300 and 550 nm.

Conventional radiation sources, such as doped Hg lamps, cause an inhomogeneous activation of adhesive layers having a thickness over 2 mm. This is assumed to be due to the wide wavelength spectrum of such radiation sources. LEDs permit an exact tuning of their spectrum to that of the photo-initiator, thus resulting in a particularly homogeneous pre-activation of adhesive layer thicknesses up to 4 mm.

The narrow-band radiation of an LED offers the further advantage that the material to be pre-activated is not exposed undesirable radiation so that no uncontrolled and undesirable heating of the material will occur.

LEDs exhibit a constant emission of radiation throughout their entire service life. There is no decrease of the radiated power over time as known with other radiation sources in the UV or VL range. Furthermore, the service life of an LED when properly controlled amounts to approximately 10,000 hours and is therefore longer by a factor of 10 than for conventional UV and VL radiation sources. At the termination of the service life the luminous efficiency drops abruptly from 100 per cent to 0, at which time the radiated power also drops to zero. Hence, a malfunction can be detected.

As another feature of an LED, the wavelength of the emission spectrum will not shift with time. This, too, differs from conventional light sources and makes the LED particularly suited for use in pre-activation.

Another property of LEDs by which they also differ essentially from conventional UV and VL radiation sources resides in the fact that, when the LED is turned on, the full radiated power is reached within milliseconds. Conventional lamps require a start-up period of several minutes. The precise controllability of LEDs avoids even small deviations in the radiation dose which otherwise cause errors in the manufacturing process and waste.

Considering the pre-exposure of a cationically polymerizable material, the aforementioned aspects as related to a manufacturing process show that even large areas of adhesive or sealing materials may be pre-exposed very precisely, because both the wavelength and the dose of the introduced energy and hence the temperature will remain constant throughout the entire period of the manufacturing process.

When pre-activation is effected with commonly used radiation sources (Hg lamps) the available potlife of the materials is considerably shortened due to the fact that these radiation sources in addition to the desired radiation spectrum also emit longer-wavelength IR radiation and also shorter-wavelength UV radiation. The IR radiation accelerates the curing process in uncontrolled fashion, i.e. the potlife is shortened, and at excessive temperatures (>50° C.) the materials to be polymerized will degas. The undesirable UV radiation in turn leads to quick skin formation on the surface of the materials thus making a subsequent joining step impossible. Both effects have a negative influence on the pre-exposure because the subsequent automated manufacturing process is highly insecure.

As the afore-mentioned undesirable radiation can be excluded by the use of an LED radiation source, faster curing is achieved while the potlife remains the same. Thereby the manufacturing process is accelerated because the handling stability is achieved more quickly. At the same time, however, there is an increase in safety, and tests for mechanical strength can be performed more quickly (less rejects).

By altering the introduced electrical energy it is possible to vary the radiated power of an LED. Consequently, the potlife of the material is extended. Increasing the radiation dose will decrease the potlife (for instance to 1 second) and hence also the entire curing process. Decreasing the radiated power will extend the potlife (e.g. to 120 seconds) and hence the entire curing process is considerably prolonged.

What is decisive for the introduction of a radiation dose the amount of which is exactly defined as to quality and quantity is the firing and cutting of an LED within the millisecond range. This enables the determination of the radiation dose, which is important for the potlife, without excessive operative effort. It is exactly this property which is of paramount importance for an exact pre-exposure of large areas because the conventional way of turning a radiation source away or of actuating a shutter necessarily results in different energy doses across the surface. Furthermore, fast and convenient on/off operation in the millisecond range enables the realization of radiation profiles for pre-activation. Thus, the introduction of a radiation dose may be effected in a repeating cycle of, for example, 4 seconds irradiation and 3 seconds interval.

If a failure occurs at the and of the service life of an LED it will occur abruptly and will be readily detectable both optically and electrically. Therefore an automatic manufacturing system can easily be equipped with a fault sensor that shuts down the automatic system in order to prevent rejections.

Since an LED has an emitting surface of about 1 mm×1 mm it is possible to construct any desired geometry for large-surface irradiation. This enables controlled matching of the radiation source to the bonding or sealing surfaces with optimum homogeneous illumination.

Conventionally, radiation dosage for the materials is effected by continually regulating the distance of the radiation source from the material to be preactivated; in case of an LED surface this distance is fixed once and the radiated power is regulated just once for the entire service life.

As an LED emits nearly monochromatic light at a good electrical efficiency, the energy consumption, particularly in case of large surfaces, is significantly lower than with conventional radiation sources. To obtain fast curing of the polymerizable materials the curing process may be accelerated by a controlled increase of the temperature of the materials (<50° C.). To this end IR LEDs are mounted on the LED surface in addition to the UV or VL LEDs. The former then provide for exact heating of the materials whereby the potlife may be regulated within a broad time window.

It is known that the luminous power decreases with the second power of the distance from the light source. Conventional radiation systems fail in the case of a three-dimensional surface to be pre-activated. Using LEDs allows direct matching of the radiation surface to a three-dimensional substrate surface. The distance of an LED from all surfaces to be pre-activated can be exactly set to just a few millimeters, and the precise radiation dose required for pre-activation is ensured across the entire three-dimensional surface.

While the use of a radiation source formed by LEDs is known from DE 297 14 686 U1, this document deals with the complete curing of dental substances by polymerization, rather than with the pre-activation of cationically polymerizing materials. There, speed, limited heating and economical considerations are of predominant importance, so that a large quantity of light at minimal temperature are essential. For providing a sufficient amount of radiation, the document proposes to combine a plurality of LEDs in a bundle.

Further features, advantages and embodiments of the invention will be explained with reference to the accompanying drawing.

### BRIEF DESCRIPTION OF THE DRAWING

FIG. 1 shows a radiation source assembled from LEDs;

FIG. 2 is a side view of the radiation source in operation; and

FIG. 3 is a modification of the radiation source.

### DETAILED DESCRIPTION OF PREFERRED EMBODIMENTS

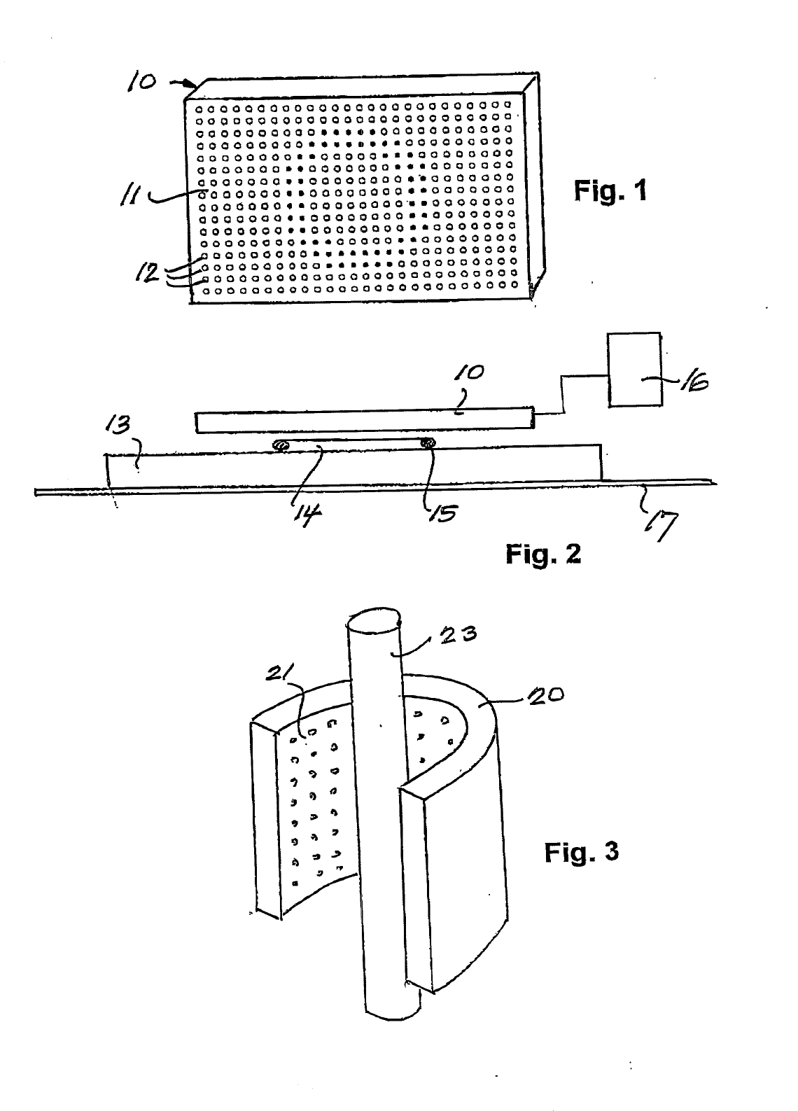

The radiation source 10 shown in FIG. 1 has a planar radiating surface 11 formed by a rectangular matrix array of 100 or more LEDs 12 which emit light at a band width of up to 50 nm in a wavelength range from 300 to 550 nm.

As shown in FIG. 2, an adhesive material 16 applied onto a substrate 13 in the shape of a ring 14 is to be pre-activated. To this end the radiation source 10 is disposed at a small spacing of up to 30 mm above the substrate 13 and turned on by a controller 16 for an interval of, for example, 2 seconds.

The controller 16 operates in such a way that only those LEDs 12 from among the overall array are turned on that conform to the shape of the adhesive ring 14. In FIG. 1 these LEDs are indicated by black dots.

Thereafter the substrate 13 with the thus pre-activated adhesive material 15 is conveyed further, and the next substrate provided with an adhesive ring is disposed beneath the radiation source 10. The timing used is 10 seconds, for example, so that the radiation source 10 is switched on/off with a 1:4 duty cycle.

In the modification shown in FIG. 3 the radiation surface 21 of the radiation source 20 is curved to form a semi-cylinder as is suitable for pre-activating adhesive material applied to shafts or other cylindrical objects 23.

What is claimed is:

1. A method of pre-activating cationically polymerizable materials by electromagnetic radiation using a radiation source that produces said radiation by LEDs.

2. The method of claim 1, wherein said LEDs have an emission wavelength band between 300 and 550 nm.

3. The method of claim 1, wherein said LEDs emit in a bandwidth of up to 50 nm.

4. The method of claim 1, wherein the radiation dose of said radiation is adjusted such that the material to be pre-activated exhibits a potlife between 1 second and 120 seconds.

5. The method of claim 1, wherein said radiation is applied to material having a thickness greater than 2 mm.

6. The method of claim 1, wherein LEDs emitting radiation at a wavelength above 800 nm are additionally employed.

7. The method of claim 1, wherein said radiation source is turned on only during periods of pre-activation.

8. The method of claim 1, wherein said radiation source is disposed at a distance of from 1 and 30 mm from the material to be pre-activated.

9. An apparatus for pre-activating cationically polymerizable materials by electromagnetic radiation comprising a radiation source formed of LEDs.

10. The apparatus of claim 9, wherein said LEDs have an emission wavelength band between 300 and 550 nm.

11. The apparatus of claim 9, wherein said LEDs emit in a bandwidth of up to 50 nm.

12. The apparatus of claim 9, wherein said radiation source further comprises LEDs emitting radiation at the wavelength above 800 nm.

13. The apparatus of claim 9, further comprising control means for turning on said radiation source only during pre-activation periods.

14. The apparatus of claim 9, wherein said radiation source is spaced from the material to be pre-activated by a distance between 1 and 30 mm

15. The apparatus of claim 9, wherein said radiation source includes a plurality of LEDs arranged to form a radiation surface.

16. The apparatus of claim 15, wherein the LEDs forming said radiation surface are arranged in a pattern conforming to the configuration of the material to be preactivated.

17. The apparatus of claim 15, further comprising control means for turning on only those of the LEDs forming said radiation surface which conform to the configuration of the material to be pre-activated.

18. The apparatus of claim 15, wherein said radiation surface is formed by at least 100 LEDs.

19. The apparatus of claim 15, wherein said LEDs are arrayed to form a three-dimensional radiation surface.

20. The apparatus of claim 9, further comprising means for generating a fault signal in case of malfunction of an LED.
